(19) United States
(12) Patent Application Publication
(10) Pub. No.: US 2005/0289043 A1
(43) Pub. Date: Dec. 29, 2005

(54) Maudlin-vickrey auction method and system for maximizing seller revenue and profit

(76) Inventor: Stuart C. Maudlin, Houston, TX (US)

Correspondence Address: ARNOLD & FERRERA, L.L.P., 2401 FOUNTAIN VIEW DRIVE, SUITE 630, HOUSTON, TX, 77057, US

(21) Appl. No.: 11/036,652

(22) Filed: Jan. 14, 2005

Related U.S. Application Data
(63) Continuation of application No. 09/450,308, filed on Nov. 29, 1999, now abandoned.

(51) Int. Cl. G06F 17/60

(52) U.S. Cl. 705/37

(57) ABSTRACT

A one-sided seller-defined method and system for maximizing a seller's profit by withholding supply in Vickery auctions based on a market-derived reserve price calculated from the buyers' bids in order to maximize revenues and/or profits to the seller(s).

### CROSS-REFERENCE TO RELATED APPLICATIONS

This application is a continuation of Ser. No. 09/450,308, filed Nov. 29, 1999, to which the instant application claims priority.

### TECHNICAL FIELD

The present invention relates in general to auction methods, and in particular to a one sided seller defined method and system for maximizing a seller's profit by withholding supply in Vickrey auctions based on a market-derived reserve price calculated from the buyers' bids in order to maximize revenues and/or profits to the seller(s).

### BACKGROUND

An auction is a method of selling goods, based upon competition among buyers. A seller wishes to obtain as much money as possible, and a buyer wants to pay as little as necessary. What is unique about auctions as a sales method is that the price is set not by the seller, but by the bidders. However, it is the seller who determines the parameters and sets the rules by choosing the type of auction to be used. An auction offers the advantage of simplicity in determining market-based prices and is efficient in the sense that it usually ensures that goods are purchased by those who value them most highly and ensures also that sellers receive the market's assessment of that value.

Not all auctions have ascending price schemes. In fact, there are many different auction formats including the familiar ascending bid, but also including the descending, sealed-bid, simultaneous, handshake, and whispered forms of bidding. Auctions can be used for single items such as a work of art and for multiple units of a homogeneous item such as gold or securities. Auctions are useful in circumstances when the goods do not have a fixed or determined market value, and therefore the seller is unsure of the price he can get.

There are different ways to classify auctions. There are open auctions as well as sealed-bid auctions. There are auctions where the price ascends and auctions where the price drops at regular intervals. William Vickrey, winner of the 1996 Nobel Prize in Economic Sciences, established the basic organization of auctions based upon the order in which prices are quoted and the manner in which bids are tendered. He established, and generally other experts agree, that there are four major one-sided auction types: English (discriminatory open ascending first-price), Dutch (discriminatory open descending first-price), Sealed-Bid (discriminatory closed first-price), and Vickrey (uniform second-price). One-sided auctions are defined as having one seller and multiple buyers, or one buyer and multiple sellers. This is in contrast to two-sided auctions which have multiple buyers and sellers, such as at the New York Stock Exchange. One difficulty is the lack of commonality in auction naming conventions. The naming convention just listed from the academic literature is not followed in the financial and commercial communities wherein the uniform second-price, or Vickrey auction, is sometimes known as a Dutch auction. Similarly, the Sealed-Bid auction is sometimes called an English auction in the financial community and a Yankee auction in Great Britain. In this disclosure, the academic convention will be followed.

The term “Discriminatory” is sometimes used to describe an auction wherein multiple identical items are offered. In a Discriminatory auction, the winning bidders each pay what they bid, which will almost always be different from what the other bidders bid. So the winners will each have purchased identical items at different prices. The term “First-Price” is an academic term that means that each bidder pays what he or she bids. First-Price auctions of multiple identical items are always Discriminatory. The term “Second-Price” is an academic term that means that each bidder will pay what a lower bidder bid (the second lowest bidder in the case of auctions of a single unique item).

There are drawbacks to some auction types. The “Winner's Curse” is recognized as the phenomenon that occurs when the winner in a First-Price auction pays more for an item than the other bidders think it is worth. In auctions wherein no bidder is sure of the worth of the item being auctioned, the winner is the bidder who made the highest guess. If bidders have reasonable information about the worth of the item, then the average of all the guesses is likely to be correct. The winner, however, offered the bid furthest from the actual value (the highest bid). Auction winners are faced with the sudden realization that their valuation of an object is higher than that of anyone else.

The English auction, also known as the open-outcry auction or discriminatory open ascending first-price auction, is used commonly to sell art, wine, cattle and numerous other goods. In the English auction, the auctioneer begins with a low price and proceeds to solicit successively higher bids from the bidders until no one will increase their bid. The item is sold to the highest bidder. One drawback of the English auction is “rings,” i.e. subsets of bidders who have banded together by agreeing not to outbid each other in order to keep the winning bid as low as possible. A further drawback of the English auction is that the bidder usually forces the bid up by one small step at a time. Often a successful bidder acquires an object for considerably less than his maximum valuation simply because he need only increase each bid by a small increment. In other words, the seller does not necessarily receive maximum value, and, from the seller's perspective, other auction types may be superior to the English auction. From the bidder's perspective, one disadvantage of the English auction is that the Winner's Curse is widespread because inexperienced participants may bid up the price. Another disadvantage to the English system is that a buyer or his or her representative must be present which may be difficult and/or expensive.

The discriminatory descending open first-price auction is the technique used in the Netherlands to auction produce and flowers, and is therefore known in academic literature as the Dutch auction. The Dutch auction uses an open format rather than a sealed-bid method. Bidding starts at an extremely high price and is progressively lowered until a buyer claims an item by calling “mine,” or by pressing a button that stops an automatic clock. When multiple units are auctioned, additional bidders press the button as price further declines. In other words, the first winner takes his prize and pays his price, with later winners paying less. When the goods are exhausted, the bidding is over.

The Dutch auction does have at least one advantage over the English auction from the seller's perspective. In an English auction, the underbidder usually forces the bid up by one small step. The winner may end up paying well under his valuation and thus the seller does not receive the maximum price. In the Dutch system, if the bidder with the highest interest really wants an item, he cannot afford to wait too long to enter his bid. That means he might bid at or near his highest valuation.

The Sealed-Bid auction has a primary characteristic of being sealed (not open-outcry like the English or Dutch varieties) and each bidder is unaware of the bids from other bidders. A winning bidder pays exactly the amount he bid. Usually, (but not always) each participant is allowed one bid, which means that bid preparation is especially important. In general, a Sealed-Bid auction has two distinct parts: a bidding period in which participants submit their bids, and a resolution phase in which the bids are opened and the winner determined. In this method, bidders may suffer from the Winner's Curse. Sealed-Bid auctions are commonly used by the United States government to auction offshore oil and gas leases.

The uniform second-price auction is commonly called the Vickrey auction, named after the previously mentioned William Vickrey. Like the Sealed-Bid auction, the bids are sealed, and each bidder is unaware of the amount of the other bids. The winner is determined by identifying the highest bid. However, the bidder does not pay what he or she bid, rather the bidder pays the amount in the second highest bid. If, for example, bidder A bids $10, bidder B bids $15, and bidder C offers $20, bidder C would win, however he would only pay the price of the second-highest bid, which is $15. When auctioning multiple units, all winning bidders pay for the items at the same price, which is the lowest winning price. The United States Treasury Department uses a Vickrey (called Dutch) auction to sell 90-day T-Bills. Several other examples of a Vickrey auction of multiple items are described below.

It seems that a seller would make more money by using a first-price auction, but that has been proven to be untrue. Bidders understand the rules and modify their bids as circumstances dictate. In the case of a Vickrey auction, bidders adjust upward. No one is deterred out of fear that he will pay too high a price. Aggressive bidders receive sure and certain awards but pay a price closer to market consensus. The price that the winning bidder pays is determined by competitors' bids alone. Less underbidding occurs because the bidders do not fear of suffering from the Winner's Curse.

Another example of a Vickrey auction of multiple identical items is the auctioning of shares in an initial public offering “IPO.” This specific example is referenced at the Cyberinvest.com website: www.cyberinvest.com/glossary/dutchauction.html. Since this is a site used primarily by the financial community, the term Dutch auction is used rather than the academic term, Vickrey auction. As set out in the glossary referenced, “The (Dutch) auction is conducted by secret bid, with all successful bidders (those bidding higher than the accepted price) getting the opportunity to buy shares at the accepted price. Those bidding at exactly the winning price get a percentage of any leftover shares.”

There are numerous patents relating to hosting auction sites using the Internet and world wide web as a networked computer environment in a computerized system of commerce. A few specific examples are U.S. Pat. No. 4,903,201, to Wagner; U.S. Pat. No. 5,545,265 to Woolston et al; U.S. Pat. No. 5,794,207 to Walker et al; U.S. Pat. No. 5,835,896 to Fisher, et al; U.S. Pat. No. 5,895,454, to Harrington; U.S. Pat. No. 5,905,975 to Ausubel; and U.S. Pat. No. 5,924,082 to Silverman et al.

U.S. Pat. No. 4,903,201, to Wagner matches buyers and sellers in an exchange driven commerce system such as NASDAQ or the New York Stock Exchange by offering an efficient marketplace that favors neither buyers nor sellers. The automated exchange driven commerce system for futures disclosed in the '201 patent describes effective communications that allow for the matching process to take place.

U.S. Pat. No. 5,545,265 to Woolston et al describes a method and apparatus for offering used and collectible goods for sale over an electronic network of consignment stores. The method presents a record of sale goods to a market for the goods over a wide area communication network for presenting the goods to a purchaser. Woolston '265 describes the use of a plurality of posting terminals and a market maker computer in a framework that establishes a bailee relationship and consignment contract with a purchaser of a good at the market maker computer that allows the purchaser to change the price of the good once the purchaser has purchased the good thereby to allow the purchaser to speculate on the price of collectibles in an electronic market for used goods while assuring the physical possession of a good with a vetted bailee.

U.S. Pat. No. 5,794,207 to Walker et al teaches a method and apparatus for effectuating bilateral buyer-driven commerce, allowing prospective buyers of goods and services to communicate a binding purchase offer globally to potential sellers, for sellers conveniently to search for relevant buyer purchase offers, and for sellers potentially to bind a buyer to a contract based on the buyer's purchase offer. The Walker disclosure provides apparatus controller which receives binding purchase offers from prospective buyers. The controller makes purchase offers available globally to potential sellers. Potential sellers then have the option to accept a purchase offer and thus bind the corresponding buyer to a contract. The method and apparatus contemplates applications on the Internet as well as conventional communications systems such as voice telephony.

U.S. Pat. No. 5,835,896 to Fisher concerns a system and method for conducting a multi-person, interactive auction, in a variety of formats, without using a human auctioneer to conduct the auction. The system is preferably implemented in software. The system allows a group of bidders to interactively place bids over a computer or communications network. Those bids are recorded by the system and the bidders are updated with the current auction status information. When appropriate, the system closes the auction from further bidding and notifies the winning bidders and losers as to the auction outcome.

U.S. Pat. No. 5,895,454, to Harrington describes a method of effecting commerce in a networked computer environment in a computerized system. A database of vendor product data and an associated database interface is established on a first computer. The interface allows remote access by one or more user(s). A local user interacts with the database by querying the database to specify a local user's product/service specification. The database provides the local user with a selection of remote vendor network sites, where the selection is determined on the basis of the user querying the database. After the local user interactively connects with one or more of the remote vendor network sites, the user selects products/services from the information provided on the remote vendor network site. The selection of a particular product/service triggers a transaction notification which records the user's selection and associated financial transaction data which is transmitted to the database and associated database interface. The local user may connect to subsequent remote vendor network sites, and each selection of a product/service also triggers a transaction notification which is transmitted to the database. The database and associated database interface provides information relating to the user's realtime selection of products/services. During or at the conclusion of a local user's shopping session, the user confirms the selection(s) whereby the database and associated database interface transmits purchase/ordering data to the remote vendor sites corresponding to the user's selection.

U.S. Pat. No. 5,905,975 to Ausubel relates to computer implemented methods and apparatus for auctions. The system has at least two intelligent systems, one for the auctioneer and at least one for a user. The auction is conducted by the auctioneer's system communications with the user system(s). The auctioneer's system contains information from the user system(s) based on bid information entered by the user(s). With this information auctioneer's system determines whether the auction can be concluded or not and appropriate messages are transmitted to the user(s).

U.S. Pat. No. 5,924,082 to Silverman et al discloses a negotiated matching system including a matching station, remote terminals associated with respective potential counter parties, a communications network for permitting communication between the remote terminals, and the matching station. Each user enters trading information and ranking information into his or her remote terminal. The matching station then uses the trading and ranking information from each user to identify transactions between counter parties that are mutually acceptable based on the ranking information, thereby matching potential counter parties to a transaction. Once a match occurs, the potential counter parties transmit negotiating messages to negotiate some or all terms of the transaction. Thus, the negotiated matching system first matches potential counter parties who are acceptable to each other based on trading and ranking information, and then enables the two counter-parties to negotiate and finalize the terms of a transaction.

It is apparent that there is a wide knowledge base and considerable expertise in the art for using a communications network to connect a computer system with a data base of items or goods for sale with potential buyers using remote terminals. The patents relating to using the Internet and world wide web as a networked computer environment in a computerized system of commerce described above (U.S. Pat. Nos. 4,903,201; 5,545,265; 5,794,207; 5,835,896; 5,895,454; 5,905,975; and 5,924,082) are each hereby specifically incorporated by reference.

There are also Internet sites that support uniform second-price auctions (Vickrey auctions). WR Hambrecht+Co offers one example of such at www.openipo.com and more specifically, www.openipo.com/offerings/auctions/openipo/index.html. As described by WR Hambrect,
“Open IPO is a new way to take companies public that opens up access to IPOs. Based on a Dutch auction system designed by Nobel Prize-winning economist William Vickrey, Open IPO uses a mathematical model that treats a bid from an individual the same as a bid from a large institution. This means Open IPO offering prices are set by the market. The result is a price that reflects what people are truly willing to pay for the stock and the likely allocation of shares to long-term investors rather than speculators.
As in a typical auction, the highest bidders win. But there are two important differences. In the Open IPO auction, bidding is completely secret, and winning bidders all pay the same price—the amount of the lowest bid at which the deal can be completed.”

Vickrey auctions have been used in settings where bidders have interdependent values and for multiple identical items with interdependent values. It has also been shown that in multiple unit auctions with variable supply in a uniform-price auction the seller can eliminate low-price equilibria by restricting supply after the bids are in. The effects of variable supply on seller revenues in both uniform-price and pay-your-bid auctions have also been considered. None of the above-described auction methods or patents disclose a seller-defined method within a commercial network system that allows the seller to maximize revenue and/or profit. Further, since the first documented occurrence of auctions in 500 B.C., auctions have been used as a method of allocating scarce resources. That is, auctions have been used when there is insufficient supply of a resource to satisfy every potential buyer's demand. Since not every buyer can be satisfied, competition among buyers drives up the price received by the seller. The method and apparatus of the present invention is the first method to allow the auctioning of non-scarce (plentiful) resources. Some examples of such plentiful resources would be: manufacturing overruns, remaindered books, and excess power generation capacity. This method is also the first method to allow the auctioning of infinite resources. Some examples of such infinite resources would be: a license to use software, the right to play or use a piece of music, or a ticket to view a movie, and other intellectual property rights. None of the prior auction methods is appropriately applied to situations where the goods to be auctioned are non-scarce, or even of infinite supply. Accordingly, there is a need for the present inventions' form of Vickrey auction with a market-derived reserve price.

### SUMMARY OF THE INVENTION

The method and apparatus of the present invention provides an auction method and a method for using a computer system and communications network to connect the computer containing a data base of items or goods for sale with potential buyers of the goods, and to facilitate a transaction between a seller and at least one buyer, or a buyer and at least one seller.

The Maudlin—Vickrey Auction is a method that allows the seller to optimize revenue over the existing Vickrey auction method. It allows bidders to submit bids at market-clearing prices in addition to bids at specific prices. A market-clearing, or “At Market,” bid is a bid with an unspecified price which indicates that the bidder will purchase a particular quantity at the same price that the winning bidders who bid a specific price will pay. The method allows sellers to select the preferred quantity to be sold if more than one quantity yields the same revenue. It allows bidders to submit bids that are pro-ratable.

The Maudlin—Vickrey Auction is a method that allows the seller to optimize net profit (revenue less production and disposal costs) in addition to optimizing revenue. It allows bidders to submit bids at market-clearing prices in addition to bids at specific prices. It allows sellers to select the preferred quantity to be sold if more than one quantity yields the same net profit. It allows bidders to submit bids that are pro-ratable.

The Maudlin—Vickrey Auction is a method that allows the auctioning of items when the supply or quantity of items available for sale exceeds the total quantity bid. It allows bidders to submit bids at market-clearing prices in addition to bids at specific prices. It allows sellers to select the preferred quantity sold if more than one quantity yields the same net profit. It allows bidders to submit bids that are pro-ratable.

The Maudlin—Vickrey Auction is a method that allows the auctioning of items when the supply available for sale is infinite. It allows bidders to submit bids at market-clearing prices in addition to bids at specific prices. It allows sellers to select the preferred quantity sold if more than one quantity yields the same net profit. It allows bidders to submit bids that are pro-ratable.

The Maudlin—Vickrey Auction is a method that allows the seller to determine the optimum quantity to be offered for sale.

The method and apparatus maximizes revenue and/or profit by withholding supply in Vickrey auctions based on a market-derived reserve price calculated from the bids. The following is a simplified outline of the steps of the method.

In a first step of the method of the present invention, a seller has to submit a sales offer for at least one item to be sold. The seller's sales offer shall not include any price information of the items to be sold. Thereafter, at least one buyer that is interested in buying these items has to submit at least one bid (purchase offer), with each bid containing a bid price and a respective bid quantity, i.e. the quantity of items he wants to buy.

In a second step, the submitted bids are sorted from high to low, based upon the respective bid prices to generate a sequence of bid elements. Each element contains a bid price, a respective bid quantity, and a cumulative bid quantity that is the sum of the bid quantity of this respective bid element and the bid quantities of all the previous bid elements. That is, the first element contains the highest bid price, the respective bid quantity and a bid amount which is equal to the bid quantity. The second element contains the second highest bid price, the respective bid quantity and a bid amount which is the sum of the first element's bid quantity and the second element's bid quantity The third element contains the third highest bid price, the respective bid quantity and a bid amount which is the sum of the third element's bid quantity, the second element's bid quantity and the first element's bid quantity, etc.

In a third step, in each element of the previously generated sequence, the cumulative bid quantity is multiplied by the respective bid price to calculate a sequence of bid revenues. The costs from production, sale of the items and the cost of disposal of the cumulative unsold items are deducted from the bid revenues to calculate bid profits. As many variables as desired could be included in such cost functions to fine tune the ability to maximize profit.

In a fourth step, from this new sequence of bid revenues and/or profits, the highest revenue and/or profit is selected and the corresponding bid price becomes the sales price. All bids At Market or that are greater than or equal to the sales price, are accepted and every winning bidder pays the same price, which is the sales price.

Those skilled in the art will readily recognize that although these examples are based on a single seller and multiple buyers, a reverse auction, with a single buyer and multiple sellers, can be performed with this method. A reverse auction would encompass the situations of withholding demand to minimize cost to the buyer.

Some examples of the invention include:

(1) A method of optimizing a Vickrey auction transaction to maximize revenue and profit to the seller, by withholding supply based on a market-derived reserve price calculated from buyer's bids.

(2) The method of example 1, comprising the steps of establishing a system for recording auction parameters and calculating an optimum selling price and a communications network for announcing the auction and collecting bids sorting received bids processing bids to determine the optimum selling price selecting the winning bids and notifying bidders of whether they won or lost based upon the calculated optimum selling price.

(3) The method of example 2 further comprising the steps of determining and recording the auction parameters, including the item(s) being offered; whether at market bids will be accepted; whether there is an announced reserve price, and if so, what it is; whether there is an unannounced reserve price, and if so, what it is; whether bids should have a minimum quantity, and if so, what it is; whether bids should have a maximum quantity, and if so, what it is; whether a prorationing scheme should be used, and if so, what it is; whether to announce the quantity available for sale; the procedure for submitting bids, whether bids may withdrawn prior to the close of the auction, and the procedure for withdrawing bids; delivery requirements; and, the closing date and time of the auction.

(4) The method of example 2 further comprising the steps of announcing the selected auction parameters; and, collecting and recording bids containing: the identity of the bidder; quantity bid for; pricing information; and whether bidder will accept partial quantity, according to the procedures selected and announced; and, rejecting nonconforming bids and noting any bid withdrawals.

(5) The method of example 2 further comprising the step of sorting and consolidating all at market bids and all price bids other than those less than the reserve price, wherein the price bids are ranked in descending price order.

(6) The method of example 3 further comprising the steps of announcing the selected auction parameters; and, collecting and recording bids containing: the identity of the bidder; quantity bid for; pricing information; and whether bidder will accept partial quantity, according to the procedures selected and announced; and, rejecting nonconforming bids and noting any bid withdrawals.

(7) The method of example 3 further comprising the step of sorting and consolidating all at market bids and all price bids other than those less than the reserve price, wherein the price bids are ranked in descending price order.

(8) The method of example 4 further comprising the step of sorting and consolidating all at market bids and all price bids other than those less than the reserve price, wherein the price bids are ranked in descending price order.

(9) The method of example 6 further comprising the step of sorting and consolidating all at market bids and all price bids other than those less than the reserve price, wherein the price bids are ranked in descending price order.

(10) The method of example 2 further comprising the steps of processing bids to determine the selling price including the steps of calculating a starting revenue by multiplying the highest price bid times the number of items wanted; calculating a comparative revenue by multiplying the next highest price bid times the number of items wanted by both the highest and next highest bidders; iteratively performing calculations with each bid in descending price order to determine the revenue realized by the next lowest price times the sum of the items required by the bidder of the next lowest price and all preceding higher bidders; determining from the calculated revenue figures the optimum selling price and number of units to be sold to realize the maximum revenue.

(11) The method of example 3 further comprising the steps of processing bids to determine the selling price including the steps of calculating a starting revenue by multiplying the highest price bid times the number of items wanted calculating a comparative revenue by multiplying the next highest price bid times the number of items wanted by both the highest and next highest bidders; iteratively performing calculations with each bid in descending price order to determine the revenue realized by the next lowest price times the sum of the items required by the bidder of the next lowest price and all preceding higher bidders; determining from the calculated revenue figures the optimum selling price and number of units to be sold to realize the maximum revenue.

(12) The method of example 4 further comprising the steps of processing bids to determine the selling price including the steps of calculating a starting revenue by multiplying the highest price bid times the number of items wanted; calculating a comparative revenue by multiplying the next highest price bid times the number of items wanted by both the highest and next highest bidders; iteratively performing calculations with each bid in descending price order to determine the revenue realized by the next lowest price times the sum of the items required by the bidder of the next lowest price and all preceding higher bidders; determining from the calculated revenue figures the optimum selling price and number of units to be sold to realize the maximum revenue.

(13) The method of example 5 further comprising the steps of processing consolidated bids to determine the selling price including the steps of calculating a starting revenue by multiplying the highest price bid times the number of items wanted; calculating a comparative revenue by multiplying the next highest price bid times the number of items wanted by both the highest and next highest bidders; iteratively performing calculations with each bid in descending price order to determine the revenue realized by the next lowest price times the sum of the items required by the bidder of the next lowest price and all preceding higher bidders; determining from the calculated revenue figures the optimum selling price and number of units to be sold to realize the maximum revenue.

(14) The method of example 6 further comprising the steps of processing consolidated bids to determine the selling price including the steps of calculating a starting revenue by multiplying the highest price bid times the number of items wanted; calculating a comparative revenue by multiplying the next highest price bid times the number of items wanted by both the highest and next highest bidders; iteratively performing calculations with each bid in descending price order to determine the revenue realized by the next lowest price times the sum of the items required by the bidder of the next lowest price and all preceding higher bidders; determining from the calculated revenue figures the optimum selling price and number of units to be sold to realize the maximum revenue.

(15) The method of example 7 further comprising the steps of processing consolidated bids to determine the selling price including the steps of calculating a starting revenue by multiplying the highest price bid times the number of items wanted; calculating a comparative revenue by multiplying the next highest price bid times the number of items wanted by both the highest and next highest bidders; iteratively performing calculations with each bid in descending price order to determine the revenue realized by the next lowest price times the sum of the items required by the bidder of the next lowest price and all preceding higher bidders; determining from the calculated revenue figures the optimum selling price and number of units to be sold to realize the maximum revenue.

(16) The method of example 8 further comprising the steps of processing consolidated bids to determine the selling price including the steps of calculating a starting revenue by multiplying the highest price bid times the number of items wanted; calculating a comparative revenue by multiplying the next highest price bid times the number of items wanted by both the highest and next highest bidders; iteratively performing calculations with each bid in descending price order to determine the revenue realized by the next lowest price times the sum of the items required by the bidder of the next lowest price and all preceding higher bidders; determining from the calculated revenue figures the optimum selling price and number of units to be sold to realize the maximum revenue.

(17) The method of example 9 further comprising the steps of processing consolidated bids to determine the selling price including the steps of calculating a starting revenue by multiplying the highest price bid times the number of items wanted; calculating a comparative revenue by multiplying the next highest price bid times the number of items wanted by both the highest and next highest bidders; iteratively performing calculations with each bid in descending price order to determine the revenue realized by the next lowest price times the sum of the items required by the bidder of the next lowest price and all preceding higher bidders; determining from the calculated revenue figures the optimum selling price and number of units to be sold to realize the maximum revenue.

(18) The method of example 3 comprising the further step of determining if the auction results are to be optimized for seller profit rather than revenue, and if so, the step of determining a cost function to be included in subsequent calculations.

(19) The method of example 4 comprising the further step of determining if the auction results are to be optimized for seller profit rather than revenue, and if so, the step of determining a cost function to be included in subsequent calculations.

(20) The method of example 5 comprising the further step of determining if the auction results are to be optimized for seller profit rather than revenue, and if so, the step of determining a cost function to be included in subsequent calculations.

(21) The method of example 6 comprising the further step of determining if the auction results are to be optimized for seller profit rather than revenue, and if so, the step of determining a cost function to be included in subsequent calculations.

(22) The method of example 7 comprising the further step of determining if the auction results are to be optimized for seller profit rather than revenue, and if so, the step of determining a cost function to be included in subsequent calculations.

(23) The method of example 8 comprising the further step of determining if the auction results are to be optimized for seller profit rather than revenue, and if so, the step of determining a cost function to be included in subsequent calculations.

(24) The method of example 9 comprising the further step of determining if the auction results are to be optimized for seller profit rather than revenue, and if so, the step of determining a cost function to be included in subsequent calculations.

(25) The method of example 10 comprising the further step of determining if the auction results are to be optimized for seller profit rather than revenue, and if so, the step of determining a cost function to be included in subsequent calculations.

(26) The method of example 11 comprising the further step of determining if the auction results are to be optimized for seller profit rather than revenue, and if so, the step of determining a cost function to be included in subsequent calculations.

(27) The method of example 12 comprising the further step of determining if the auction results are to be optimized for seller profit rather than revenue, and if so, the step of determining a cost function to be included in subsequent calculations.

(28) The method of example 13 comprising the further step of determining if the auction results are to be optimized for seller profit rather than revenue, and if so, the step of determining a cost function to be included in subsequent calculations.

(29) The method of example 14 comprising the further step of determining if the auction results are to be optimized for seller profit rather than revenue, and if so, the step of determining a cost function to be included in subsequent calculations.

(30) The method of example 15 comprising the further step of determining if the auction results are to be optimized for seller profit rather than revenue, and if so, the step of determining a cost function to be included in subsequent calculations.

(31) The method of example 16 comprising the further step of determining if the auction results are to be optimized for seller profit rather than revenue, and if so, the step of determining a cost function to be included in subsequent calculations.

(32) The method of example 17 comprising the further step of determining if the auction results are to be optimized for seller profit rather than revenue, and if so, the step of determining a cost function to be included in subsequent calculations.

(33) The method of example 8 further comprising the step of comparing the total number of items available to that required to supply all bidders that bid at or above the optimum selling price to determine if there are additional items available for sale, and if so processing bids made at market.

(34) The method of example 16 further comprising the step of comparing the total number of items available to that required to supply all bidders that bid at or above the optimum selling price to determine if there are additional items available for sale, and if so processing bids made at market.

(35) The method of example 23 further comprising the step of comparing the total number of items available to that required to supply all bidders that bid at or above the optimum selling price to determine if there are additional items available for sale, and if so processing bids made at market.

(36) The method of example 33 further comprising the step of processing at market bids to determine if there are sufficient items available to supply all the at market demand, and if not, further comprising the step of applying the selected prorationing scheme.

(37) The method of example 34 further comprising the step of processing at market bids to determine if there are sufficient items available to supply all the at market demand, and if not, further comprising the step of applying the selected prorationing scheme.

(38) The method of example 35 further comprising the step of processing at market bids to determine if there are sufficient items available to supply all the at market demand, and if not, further comprising the step of applying the selected prorationing scheme.

(39) A method of using a computer system and a communications network for facilitating a transaction between at least one seller and at least one buyer, including the steps of: submitting a sales offer for items to be sold; submitting at least one price bid from at least one buyer; determining from the submitted bids a sales price to reach the maximum profit; and selling items to the buyers offered a bid price which is equal or higher than the determined sales price, wherein the items are sold to said buyers for the same sales price.

(40) The method of example 39, further including the steps of: sorting the submitted bids from high to low based on the respective bid prices; generating a sequence of cumulated bid quantities; multiplying of each element of said sequence of cumulated bid quantities and the respective bid amount to generate to sequence of bid revenues; and selecting the highest revenue from the sequence of revenues to determine the respective bid price as the sales price.

(41) The method of example 40, wherein at market bids are accepted, comprising the step of comparing the total number of items available to that required to supply all bidders that bid at or above the optimum selling price to determine if there are additional items available for sale, and if so processing bids made at market; further including the steps of: sorting the submitted bids from high to low based on the respective bid prices; generating a sequence of cumulated bid quantities; multiplying of each element of said sequence of cumulated bid quantities and the respective bid amount to generate to sequence of bid revenues; and selecting the highest revenue from the sequence of revenues to determine the respective bid price as the sales price.

(42) The method of example 40, further including the step of determining a cost profile and including the cost profile in the calculations to generate a sequence of bid profits; and selecting the highest profit to determine the sales price.

(43) The method of example 41, further including the step of determining a cost profile and including the cost profile in the calculations to generate a sequence of bid profits; and selecting the highest profit to determine the sales price.

(44) The method of example 42 further comprising the steps of determining a prorationing scheme; processing at market bids to determine if there are sufficient items available to supply all the at market demand, and if not, further comprising the step of applying the selected prorationing scheme.

(45) These and other features and advantages will be more clearly understood from the following detailed description viewed in conjunction with the accompanying drawings. It is important to note that the drawings are illustrative and are not intended to represent the only form of the invention.

### BRIEF DESCRIPTION OF THE DRAWINGS

FIG. 1 shows a flow chart outlining the process of sorting SUBMITTED_BIDS into SORTED_BIDS.

FIG. 2 shows a flow chart of an outline for the step of processing SORTED_BIDS into CONSOLIDATED_BIDS.

FIG. 3 shows a flow chart for the first stage of the iterative step of processing CONSOLIDATED_BIDS.

FIG. 3B shows a flow chart for the second stage of the iterative step of processing CONSOLIDATED_BIDS.

FIG. 4 shows a flow chart for steps of processing SUBMITTED_BIDS into a BID-STATUS file.

FIG. 5 shows an exemplary list of bids from several bidders.

FIG. 6 shows a table of the bids in FIG. 5 sorted from high to low which will be used to determine the selling price for the items.

### DETAILED DESCRIPTION OF THE INVENTION

For a more complete understanding of the present invention, and the advantages thereof, reference is now made to the following description and tables taken in conjunction with the accompanying drawings. In the following description, well-known elements within the skills of persons of ordinary skill in the relevant art are presented without detailed description in order not to obscure the present invention in unnecessary detail. In a preferred embodiment the apparatus of the present invention includes a microprocessor for storing data and performing iterative calculations. The data stored comprises a listing of items or goods for sale by auction and parameters selected by the seller or sellers determining the ground rules of the sale. The apparatus further includes a communications network for connecting the data base with potential buyers. The method and apparatus of the present invention have applications on the Internet as well as conventional communications systems.

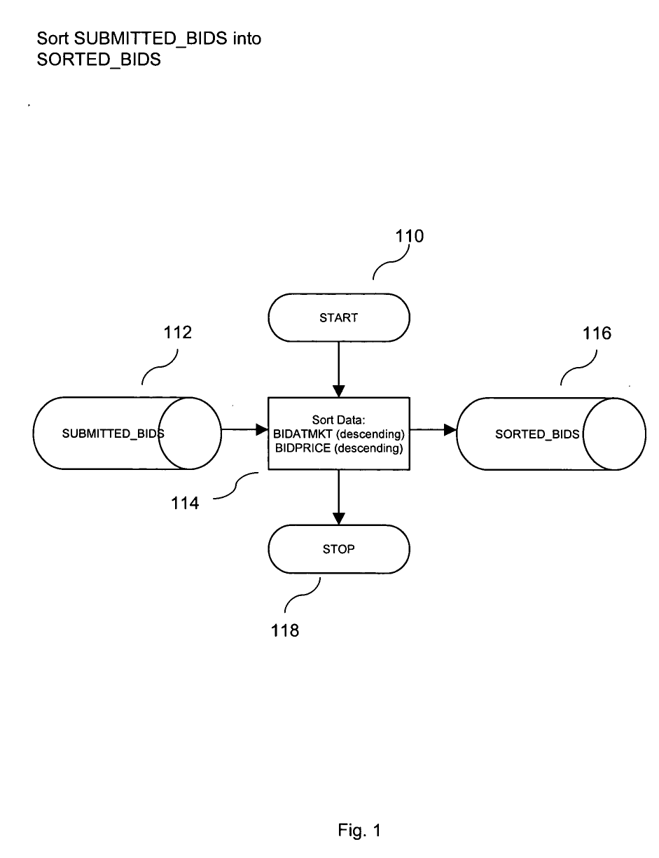

Referring now to FIGS. 1-4 and Table 1 listed below, to begin the method of holding a Vickrey auction optimized by the method of the current invention, the seller states: the item(s) being offered, the procedure for submitting (and withdrawing) bids (including any contractual arrangements that must be made in order for the bids to be binding), delivery requirements (when and where successful bidders should pick up items), whether bids may withdrawn prior to the close of the auction, and the closing date and time of the auction. The seller also decides: whether “at market” bids will be accepted, whether there is an announced (publicly known) reserve price, and if so, what it is, whether bids should have a minimum quantity, and if so, what it is, whether bids should have a maximum quantity, and if so, what it is, and whether to announce the quantity available for sale.

As part of the method of establishing the rules of the auction, the seller determines: the cost profile for production or sale of items and cost of disposal of unsold items, any allocation policy, including prorationing, among multiple bids at selling price, and whether there will be an unannounced reserve price, and if so, what it is. The seller must also decide, in the event more than one price yields the same profit, whether to sell the minimum quantity that will yield that profit, the maximum quantity that will yield that profit, or whether the winning price will be decided outside the process. This decision may be made necessary by situations where more than one price yields the same profit. An example of a decision controlled “outside the process” would be to base the selection on the number of units allowed to be sold on a desire to build market share rather than premium brand identification. In such a case the greater number of goods would be selected.

TABLE 1
Seller Data Definitions

Seller Data

| | | |
|---|---|---|
| AMOK | will “at market” bids accepted | 0 = no |
| | | 1 = yes |
| PUBRESOK | is there a publicly posted reserve | 0 = no |
| | price | 1 = yes |
| PUBRES | publicly posted reserve price | |
| MINQTY | minimum bid quantity | 0 = no minimum bid |
| | | quantity |
| MAXQTYOK | is there a maximum bid quantity | 0 = no |
| | | 1 = yes |
| MAXQTY | maximum bid quantity | |
| SUPPLY | total quantity available for sale | |
| PRIVRESOK | is there a private reserve price | 0 = no |
| | | 1 = yes |
| PRJVRES | private reserve price | |
| MNMXFLAG | when more than one price yields | 0 = minimum, |
| | the same profit, should the | 1 = maximum |
| | minimum quantity be sold or | |
| | the maximum | |
| COST(Q) | what is the cost of producing or | |
| | selling Q items plus the cost of | |
| | disposing of SUPPLY-Q items | |

The seller announces the auction by publicly disclosing the information set out above and provides for collecting bids received and inputting both the auction parameters selected and bids received into a microprocessor capable of iterative calculations.

Referring now to FIGS. 1-4 and Table 2 set out below, bids are collected as bidders submit bids according to the procedures the seller established until the auction close. If bids may be withdrawn, bidders submit bid withdrawals until the auction close. Bidders may submit multiple bids and have multiple non-withdrawn bids outstanding at the auction close. Bids must contain the following information: identity of the bidder, quantity bid for, price (or at market), whether bidder will accept partial quantity or will only accept full quantity.

TABLE 2
Bidder Data Dermitions

Bidder Data

| | | |
|---|---|---|
| SUBMITTED_BIDS | | |
| SORTED_BIDS | | |
| BIDID | predetermined code that uniquely | |
| | identifies the bidder | |
| BIDQTY | quantity bid for | |
| BIDATMKT | is this bid “at market” | 0 = no, |
| | | 1 = yes |
| BIDPRICE | price bid | |
| BIDPRO | will the bidder accept a partial | 0 = no, |
| | (prorated) quantity | 1 = yes |

Referring now to FIGS. 1-4 and Table 3 set out below, after the auction close or as each bid is received until the auction close (at the Seller's option), bids not conforming the auction requirements are rejected. After action close, all non-rejected bids are entered into the SUBMITTED_BIDS file using all the data defined in Table 2.

The next step to the method of the present invention is to process the SUBMITTED_BIDS file into SORTED_BIDS file using the steps of the procedure set out in FIG. 1. SORTED_BIDS uses the same structure as SUBMITTED_BIDS, see Table 2.

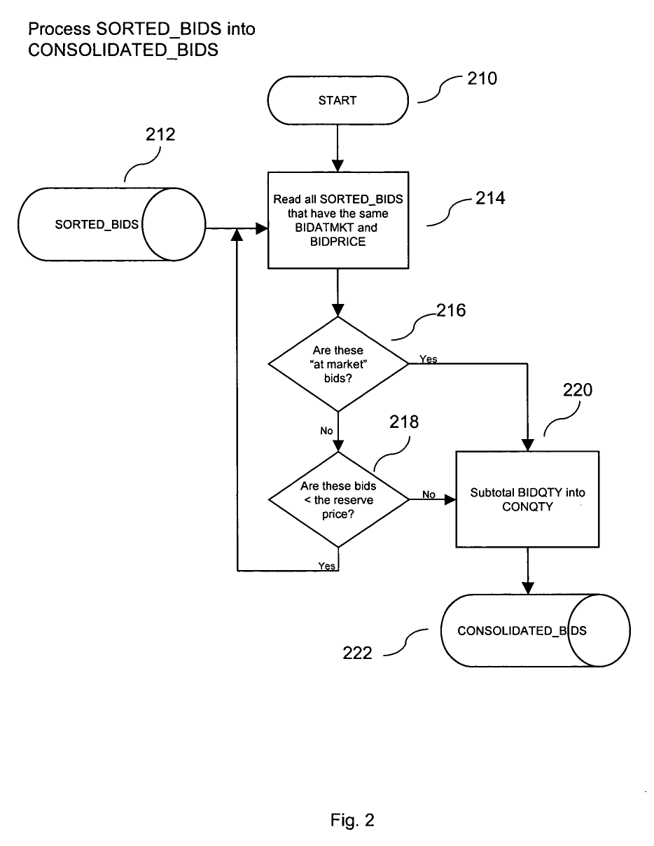

Following the step of processing the SUBMITTED_BIDS file into SORTED_BIDS file, the data is next processed to convert the SORTED_BIDS file into the CONSOLIDATED_BIDS file using the steps of the procedure set out in FIG. 2. CONSOLIDATED_BIDS Data Definitions are given in Table 3 below.

TABLE 3
Data Definitions

CONSOLIDATED_BIDS Data

| | | |
|---|---|---|
| CONATMKT | are these bids “at market” | 0 = no, |
| | | 1 = yes |
| CONPRICE | price bid | |
| CONQTY | quantity bid | |

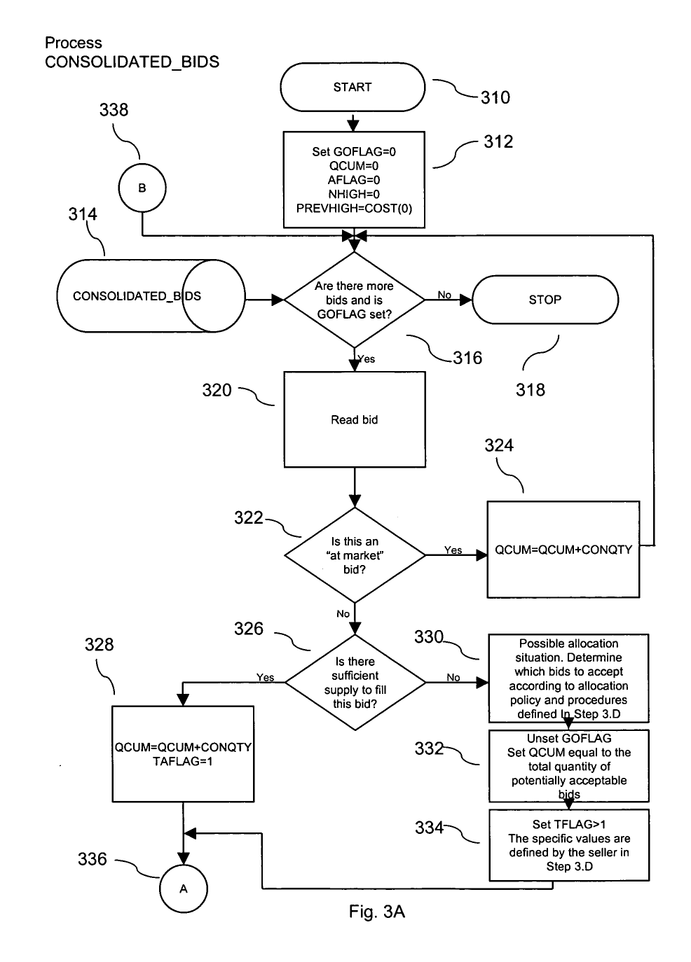

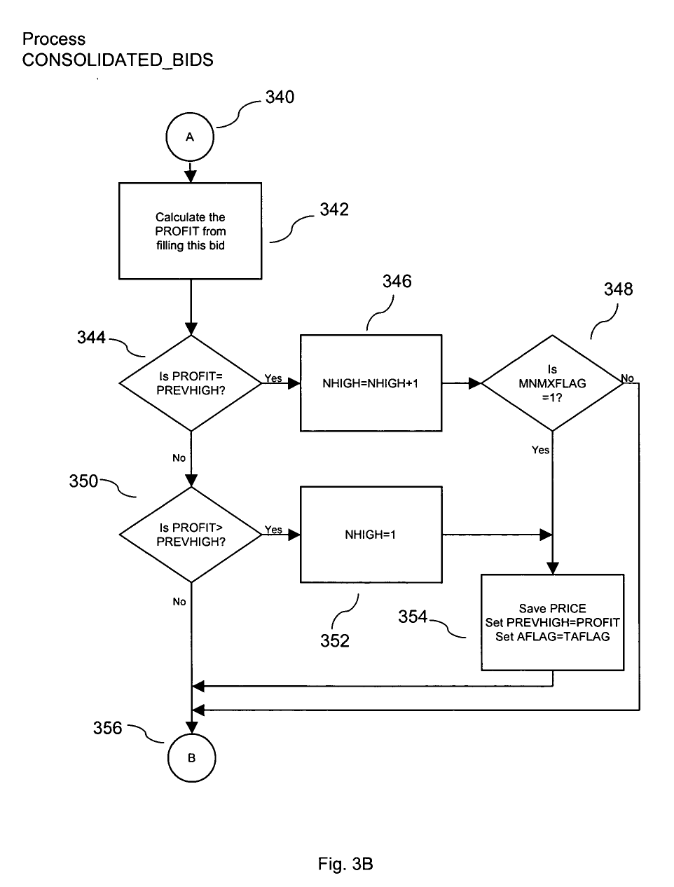

The next step of the method of the present invention is to process the CONSOLIDATED_BIDS file to determine the selling price, if any, using the steps of the procedure illustrated in FIGS. 3A and 3B. Table 4 below sets out illustrative Intermediate Result Data Definitions.

TABLE 4
Intermediate Result Data Definitions

Intermediate Results Data

| | | |
|---|---|---|
| PRICE | winning bid price | |
| AFLAC | allocation status flag | 0 = no bids accepted |
| | | 1 = all bids at and above PRICE |
| | | are accepted |
| | | 2 or more = Set according to |
| | | Seller's established allocating |
| | | procedure |

| | |
|---|---|
| NHIGH | number of price points that generate the maximum profit |

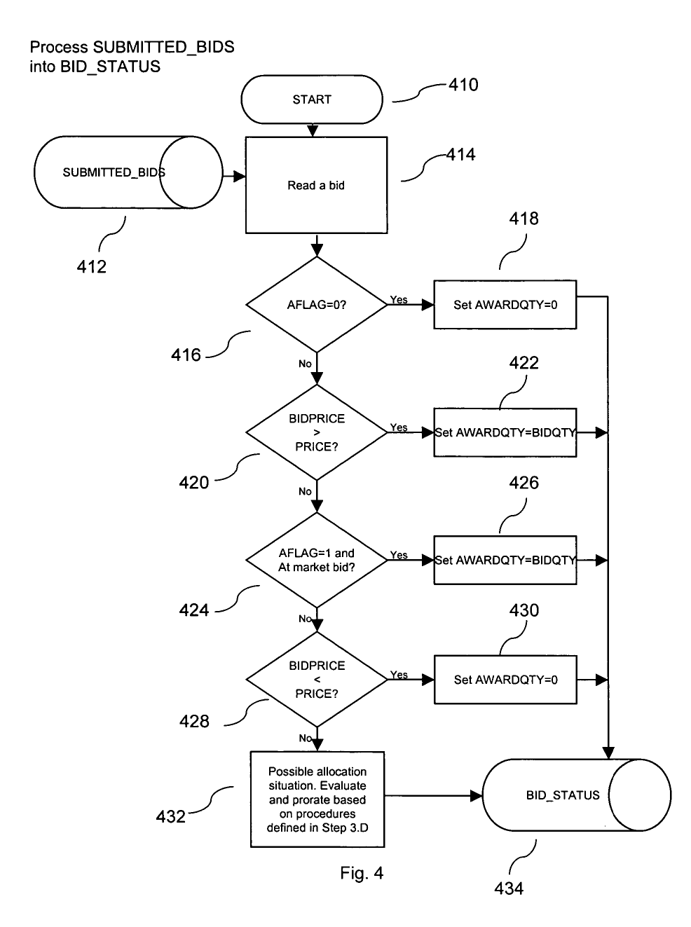

The next step of the method of the present invention is to process the SUBMITTED_BIDS file into BID_STATUS file using the steps of the procedure illustrated in FIG. 4. Table 5 below sets out BID_STATUS Data Definitions.

TABLE 5
BID_STATUS Data DefinitionsBlD_STATUS Data

| | |
|---|---|
| BIDID | predetermined code that uniquely identifies the bidder |
| AWARDQTY | quantity awarded |

The final steps in the method of the present invention are to notify bidders of whether they won or lost using the information in the BID_STATUS file.

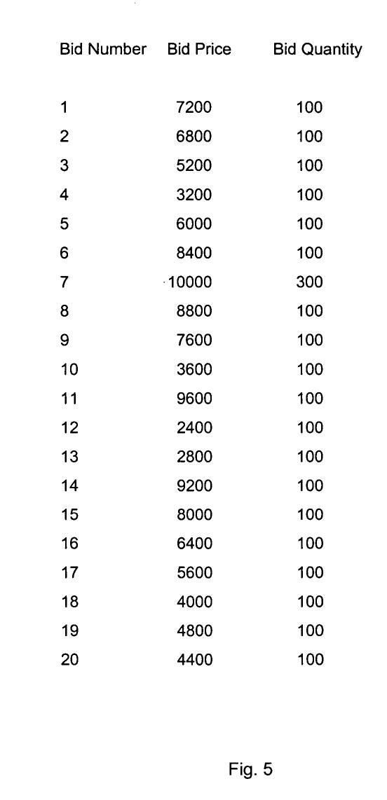

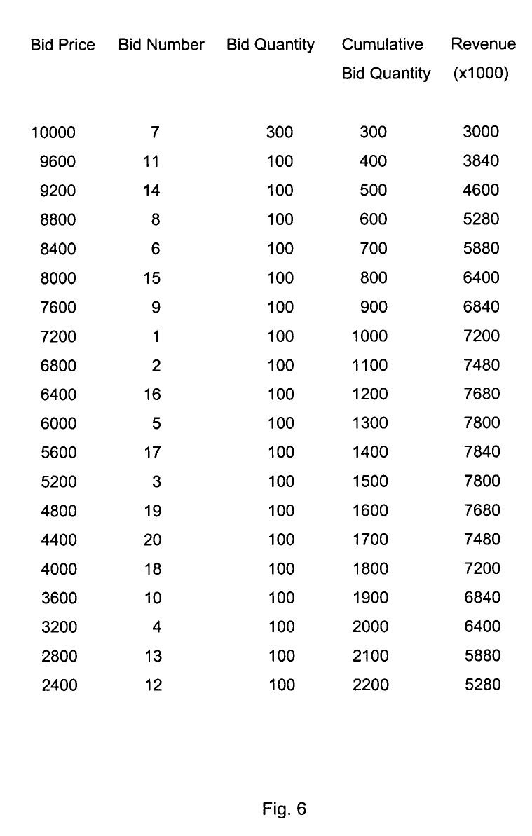

With the above detailed description and FIGS. 1-4 in mind, a brief and simplistic example of the process and method of the present invention will be given, with reference to the additional FIGS. 5 and 6. As one can see from FIG. 5, several bidders have submitted their bids. The bids contain different bid prices and different bid quantities. For example bid No. 1 contains a bid quantity of 100 items and a bid price of $7200 per item, i.e. the buyer has interest to buy 100 items and does not want to pay more than $7200 for one item. Bid No. 2 contains a bid quantity of 100 items and a bid price of $6800 per item, i.e. the buyer has interest to buy 100 items and does not want to pay more than $6800 for one item.

FIG. 6 presents a table with four columns. The first column contains the bid prices for the respective bids sorted from high to low. The second column contains the bid quantities for the respective bids. The third column contains a sequence of the cumulated bid amounts. As one can see from FIG. 6, the first line of the table lists bid No. 7 in FIG. 5. Thus, the first element of the first column is the highest bid price of $10000, the first element of the second column is the bid quantity (300 items) that belongs to this bid price, the first element of the third column is a bid amount that is equal to the bid quantity of the highest bid quantity of 300 items. The first element of the fourth column is the revenue of the highest bid, i.e. the result of a multiplication of the highest bid price of $10000 (first element of the first column) and the respective bid amount of 300 items. The second line of the table lists bid No. 11 in FIG. 5. Thus, the second element of the first column is the second highest bid price of $9600, the second element of the second column is the bid quantity (100 items) that belongs to this bid price, the second element of the third column is a bid amount that is the sum (400 items) of the respective bid quantity of 100 items and the highest bid quantity of 300 items. The second element of the fourth column is the revenue of the second highest bid, i.e. the result of a multiplication of the second highest bid price of $9600 (second element of the first column) and the respective bid amount of 400 items. The table set out in FIG. 6 therefore lists the ranking of bids and the result of the calculations. It is apparent that revenue is maximized at the price of $5600.00, and that the number of units sold at that price is 1400 for a total revenue of $7,840,000.00.

Although these examples and illustrations above are based on a single seller and multiple buyers, a reverse auction, with a single buyer and multiple sellers, can be performed with this method. A reverse auction would encompass the situations of withholding demand to minimize cost to the buyer. Although there are several techniques for converting the methodology of an auction to a reverse auction, the simplest is to reverse the sign of the bids (make them negative) and to use the same process outlined above. An example of a reverse auction is a company stock buy-back program.

As to the manner of operation and use of the present invention, the same is made apparent from the foregoing discussion. With respect to the above description, it is to be realized that although an enabling embodiment is disclosed, the enabling embodiment is illustrative, and the optimum relationships for the steps of the invention and calculations are to include variations in size, material, shape, form, function and manner of operation, assembly and use, which are deemed readily apparent to one skilled in the art in view of this disclosure, and all equivalent relationships to those illustrated in the drawings and encompassed in the specifications are intended to be encompassed by the present invention.

Therefore, the foregoing is considered as illustrative of the principles of the invention and since numerous modifications will readily occur to those skilled in the art, it is not desired to limit the invention to the exact construction and operation shown or described, and all suitable modifications and equivalents may be resorted to, falling within the scope of the invention.

1. A method of optimizing a Vickrey auction transaction to maximize revenue and profit to the seller comprising the steps of:
calculating a market-derived reserve price from buyers' bids;
withholding supply based upon said market-derived reserve price:
recording auction parameters;
announcing the auction;
collecting bids in response to said announcing;
sorting collected bids, whereby a set of bids conforming to the recorded auction parameters is defined;
processing bids to determine the selling price, wherein said processing comprises:
calculating a starting revenue by multiplying the highest price bid times the number of items wanted;
calculating a comparative revenue by multiplying the next highest price bid times the number of items wanted by both the highest and next highest bidders;
iteratively performing calculations with each bid in descending price order to determine the revenue realized by the next lowest price times the sum of the items required by the bidder of the next lowest price and all preceding higher bidders;
determining from the calculated revenue figures the optimum selling price and number of units to be sold to realize the maximum revenue; and
selecting winning bids based on the optimum selling price.

2. (canceled)

3. (canceled)

4. A method as in claim 1, further comprising determining and recording the auction parameters, including, the item(s) being offered, whether at market bids will be accepted, whether there is an announced reserve price, and if so what it is, whether there is an unannounced reserve price, and if so, what it is, whether bids should have a minimum quantity, and if so, what it is, whether bids should have a maximum quantity, and if so, what it is, whether a prorationing scheme should be used, and if so, what it is, whether to announce the quantity available for sale, the procedure for submitting bids, whether bids may be withdrawn prior to the close of the auction, the procedure for withdrawing bids, delivery requirements, and the closing date and time of the auction.

5. The method of claim 1 further comprising the steps of
announcing the selected auction parameters;
collecting and recording bids consisting essentially of: the identity of the bidder, quantity bid for, pricing information, whether bidder will accept partial quantity, according to the procedures selected and announced;
rejecting nonconforming bids; and
noting any bid withdrawals.

6. The method of claim 1 comprising the further step of determining if the auction results are to be optimized for seller profit rather than revenue, and, if so, the step of determining a cost function to be included in subsequent calculations.

7. The method of claim 1 further comprising the step of comparing the total number of items available to that required to supply all bidders that bid at or above the optimum selling price to determine if there are additional items available for sale, and, if so, processing bids made at market.

8. The method of claim 1 further comprising the step of processing at market bids to determine if there are sufficient items available to supply all the at market demand, and, if not, further comprising the step of applying the selected prorationing scheme.

9. A method of providing at least one bid acceptance signal, based on an optimization characteristic, of bids to purchase multiple items that have substantially the same characteristics, the method comprising:
generating a signal representative of an auction offer of at least some of the multiple items;
receiving a set of signals representative of bids,
wherein a set of bid signals is defined and
wherein each of the set of bid signals includes a price component and a volume component;
ranking the set of bids, wherein the ranking is dependent on a function of:
(a) the individual price component and
(b) a sum of all volume components bid at or above the individual price component;
generating a clearing price signal, wherein the generating is dependent on the optimization characteristic and on the set of ranking parameters; and
generating a set of acceptance signals,
wherein each acceptance signal of the set is for a bid having a price component at or above the clearing price,
wherein the acceptance signal includes a price component equal to the clearing price and a volume component equal to the volume accepted, and
wherein the set of acceptance signals comprises an acceptance signal corresponding to each bid signal having a price component equal or greater than the clearing price.

10. A method as in claim 9 wherein the optimization characteristic comprises total revenue.

11. A method as in claim 9 wherein the optimization characteristic comprises profit.

12. A method as in claim 9 wherein the ranking parameter for each individual sales price bid is further dependent on a cost parameter for the sum of all volume components bid at or above the individual price component.

13. A method as in claim 9 wherein the volume component consists essentially of a fixed volume component.

14. A method as in claim 9 wherein the volume component consists essentially of a maximum volume component.

15. A method as in claim 9 wherein the signal representative of the outcome offer is dependent on an at market acceptance flag signal,
a publicly posted reserve price flag signal,
a publicly posted reserve price signal,
a minimum bid quantity flag signal,
a minimum bid quantity signal,
a total quantity available for sale signal,
a private reserve price flag signal,
a minimum/maximum quantity to be sold flag signal, and
a cost signal.

16. A method as in claim 9 wherein said set of signals representative of bids consists essentially of bid signals, wherein each bid signal comprises;
a bidder identity signal,
the volume component,
the price component, and
a partial quantity acceptance flag signal.

17. A method as in claim 9 further comprising:
generating the set of signals representative of the bids before said receiving the set of signals representative of the bids, wherein said generating comprises:
selecting, from a set of submitted bids, those submitted bids having a maximum price component of at market or higher than a reserve price,
whereby a set of consolidated bid signals results and whereby a set of consolidated bid signals results, and
whereby said receiving a set of signals representatives of bids comprises receiving the set of consolidated bid signals.

18. A method as in claim 17 wherein said reserve price comprises a public reserve price.

19. A method as in claim 17 wherein said reserve price comprises a private reserve price.

20. A method as in claim 17 wherein said generating a set of acceptance signals comprises generating a bid status file comprising, for each of the set of consolidated bid signals, a code that identifies the bidder and a code that identifies the quantity awarded.

21. A method as in claim 17 wherein said generating a set of acceptance signals further comprises generating notification signal to at least those bidders having made bids with price components above the clearing price.

22. A method of generating a clearing price signal for an auction of multiple items of substantially similar characteristics in which the seller attaches at least some value to the items, the method comprising:
ranking the set of bids, wherein each of the set of bid signals includes a price component and a volume component, wherein the ranking is dependent on a function of:
(a) the individual price component and
(b) a sum of all volume components bid at or above the individual price component;
generating a clearing price signal, wherein the generating is dependent on the optimization characteristic and on the set of ranking parameters; and
generating a set of acceptance signals,
wherein each acceptance signal of the set is for a bid having a price component at or above the clearing price,
wherein the acceptance signal includes a price component equal to the clearing price and a volume component equal to the volume accepted, and
wherein the set of acceptance signals comprises an acceptance signal corresponding to each bid signal having a price component equal or greater than the clearing price.

23. A method as in claim 22 wherein said ranking is further dependent on a seller value parameter.

24. A method as in claim 23 wherein the seller value parameter is positive.

25. A method as in claim 23 wherein the seller value parameter is negative.
